(19) United States
(12) Patent Application Publication
(10) Pub. No.: US 2009/0166161 A1
(43) Pub. Date: Jul. 2, 2009

(54) POWER CIRCUIT-SWITCHING DEVICE

(76) Inventor: Chien-Hua Chen, San-Chong City (TW)

Correspondence Address: SCHMEISER, OLSEN & WATTS, 22 CENTURY HILL DRIVE, SUITE 302, LATHAM, NY, 12110, US

(21) Appl. No.: 12/184,263

(22) Filed: Aug. 1, 2008

(30) Foreign Application Priority Data
Dec. 27, 2007 (TW) 096222244

(51) Int. Cl. H01H 33/02

(52) U.S. Cl. 200/237

(57) ABSTRACT

A power circuit-switching device is proposed, which includes: a frame body; at least an electric control unit having a control member, provided with a plurality of first positioning portions and first coupling portions; and at least an operative element having an operating face and a coupling face opposite to the operating face, the coupling face having a plurality of second positioning portions and second coupling portions formed thereon in an corresponding manner, such that each of the second coupling portions can be coupled to first coupling portions, and each of the second positioning portions can be coupled to first positioning portions respectively, thereby providing for easy alignment in installation and avoiding misalignments and misuse that would otherwise cause damage to the components or electrical hazards.

### BACKGROUND OF THE INVENTION

1. Field of the Invention

The present invention is related to a power circuit-switching device, and more particularly, to a power circuit-switching device that has a simple structure and provides easy installation.

2. Description of Prior Art

In modern dwellings it is common, if not essential, to have power supply circuit devices provided at various locations. The most often-seen means to install a standard power circuit box is to embed the circuit box in the wall of a building to allow power circuits to pass therethrough. Thereafter, users may choose to install and embed a power circuit-switching device into the circuit box for eletrical connection therebetween to gain access to the electrical circuits accessible therefrom.

A notable disadvantage of using the aforesaid power box is that its dimensions need to be made to comply with specifications stipulated in electrician regulations, adversely restricting the size of the control unit employed in a power circuit-switching device that in turn restricts the use and deployment of the operative elements (i.e. switching elements exposed from the wall) to be assembled on the wall surfaces. In other words, the dimensions of the operative elements are constrained in compliance with that of the power control unit in a power switching device.

FIG. 1a illustrates a known power circuit-switching device 1 comprised of a frame body 10 formed with an opening 100, three power control units 11 disposed adjacent to one another in the opening 100, wherein a groove 110 is formed towards each of two ends of the outward-facing side of each power control unit 11; three operative elements 12a, 12b and 12c each coupled to a corresponding groove 110; and three hooks 120a, 120b and 120c.

As can be seen from the drawing, after being assembled, the width of the three operative elements 12a, 12b and 12c becomes larger than that of the opening 100. To accommodate all three power control units 11 in the opening 100, the corresponding positions of coupling each of the three operative elements 12a, 12b and 12c to the power control units 11 will be different. For instance, the hook 120a of the operative element 12a is posited in the middle; the hook 120b of the operative element 12b is posited at the right-hand side, which is closer to one side of the operative element 12a; and the hook 120c of the operative element 12c is posited at the left-hand side, which is closer to the other side of the operative element 12a. This design requires the creation and use of three different molds for the operative elements 12a, 12b, 12c, and thus increases manufacturing costs.

Moreover, in that the width of the aligned and assembled operative elements 12a, 12b and 12c is larger than that of the opening 100, the position of locking the frame body 10 with the power box is blocked, such that all three operative elements 12a, 12b and 12c need to be made disassemblable such that they can be disassembled as required in order to reveal the locking position for the installation of the power circuit-switching device 1. In the above method of installing the power circuit-switching device 1, only hooks and coupling grooves are employed for assembly and disassembly purposes. However, the design is inefficient and inconvenient to align, and misalignments may occur which can cause damage to the components.

FIG. 1b shows another conventional power circuit-switching device 2 that comprises subtantially the same constituent elements as the previous circuit-switching device 1 described above. The power circuit-switching device 2 consists of a frame body 20, a plurality of electric control units 21 and operative elements 22, and mainly differs from the foregoing in that each of the electric control units 21 comprises a first positioning portion 211 disposed at an edge of first and second coupling portions 210, which is a rib protrusion in this embodiment, wherein each of the operative elements 22 comprises a second positioning portion 221 disposed on first and second coupling portions 220 in an alternative manner. After each operative element 22 is installed in the electric control unit 21, the first and second coupling portions 210 are coupled to first and second coupling portions 220 to be fastened by the first positioning poriton 211 and the second positioning portion 221. In assembly, it is crucial to align the first positioning poriton 211 accurately with the second positioning portion 221; however, misalignments do occur and forced installation can or will cause damage to the elements and may even lead to a short circuit as a consequence of improper installation.

As such, it is desirable and beneficial to provide a power circuit-switching device that can improve on the drawbacks of prior techniques as described above.

### SUMMARY OF THE PRESENT INVENTION

In light of the drawbacks associated with the conventional techniques, a primary objective of the present invention is to provide a power circuit-switching device having a simple structure that can be assembled and disassembled with ease and efficiency.

Another objective of the present invention is to provide a power circuit-switching device that can be safely installed and securely held in place.

Another objective of the present invention is to provide a modularized power circuit-switching device that can easily be connected to and disconnected from the system.

Another objective of the present invention is to provide a power circuit-switching device comprising operative elements that are easily installed and fastened, and that also can be flexibly installed at different positions as required by the installation situation.

In accordance with the foregoing and other objectives, the present invention provides a power circuit-switching device comprising: a frame body formed with an opening and a plurality of first coupling portions disposed at the periphery of the opening; at least an electric control unit having a circuit switch and a control member, the control member being disposed in a swinging manner and exposed from the circuit switch, the portions of the operative element exposed from the circuit switch having a plurality of first positioning portions and first coupling portions formed thereon, and the circuit switch being provided with a plurality of second coupling portions corresponding to the first coupling portions; and at least an operative element having an operating face and a coupling face opposite to the operating face, the coupling face having a plurality of second positioning portions and second coupling portions formed thereon in an alternative manner, thereby allowing each of the second coupling portions to be coupled to first coupling portions, and each of the second positioning portions to be coupled to first positioning portions, respectively.

In one preferred embodiment, one end of the circuit switch may comprise an indicator light; one end of the control member may comprise a first limiting portion; and the operative member may comprise a second limiting portion corresponding to the first limiting portion, the first limiting portion being a groove and the second limiting portion being a rib protrusion corresponding to the groove, wherein the operative member is formed with a slot corresponding to the indicator light and penetrating through the operative face and the coupling face and having a light-permeable cover, the coupling face being provided with a pressing portion for abutting against an edge end of the light-permeable cover, wherein the operative member is a T-shaped cross sectional structure.

In comparison to prior techniques that use various hooks to fasten the elements posited at different positions, the circuit-switching device proposed by the present invention is characterized in that every operative element thereof has an identical and compatible structure that facilitates accurate alignment and thus easy installation by means of the positioning structure provided therein, thereby avoiding the need to use different manufacturing molds and also avoiding misalignment during installation that could cause damage to the components due to improper installation. Accordingly, the present invention yields advantages over prior techniques and has high industrial applicability.

### BRIEF DESCRIPTION OF THE DRAWINGS

The present invention can be more fully understood by reading the following detailed description of the preferred embodiments, with reference made to the accompanying drawings, wherein:

FIG. 1a is an exploded perspective view showing a conventional circuit-switching device of the prior art;

FIG. 1b is an exploded perspective view showing another conventional circuit-switching device of the prior art;

FIG. 2 is an exploded perspective view showing a first embodiment of the circuit-switching device in accordance with the present invention;

FIG. 3 is a cross-sectional side view showing the operative member of the circuit-switching device in accordance with the present invention;

FIG. 4 is a perspective view showing the control member of the circuit-switching device in accordance with the present invention;

FIG. 5 is a cross-sectional side view showing the operative member assembled with and coupled to the control member of the circuit-switching device in accordance with the present invention;

FIG. 6 is an exploded perspective view showing a second embodiment of the circuit-switching device in accordance with the present invention.

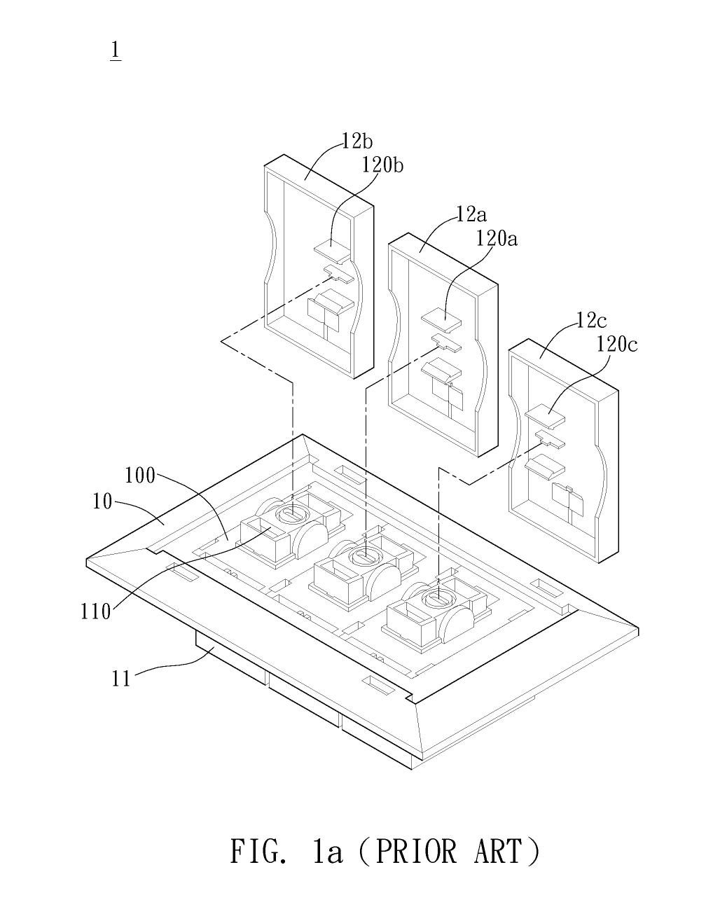

### DETAILED DESCRIPTION OF THE PREFERRED EMBODIMENTS

The following illustrative embodiments are provided to illustrate the disclosure of the present invention. These and other advantages and effects can be readily understood by persons skilled in the art after reading the disclosure of this specification. The present invention can also be performed or applied by other differing embodiments. The details of the specification may be changed on the basis of different points and applications, and numerous modifications and variations can be devised without departing from the spirit of the present invention.

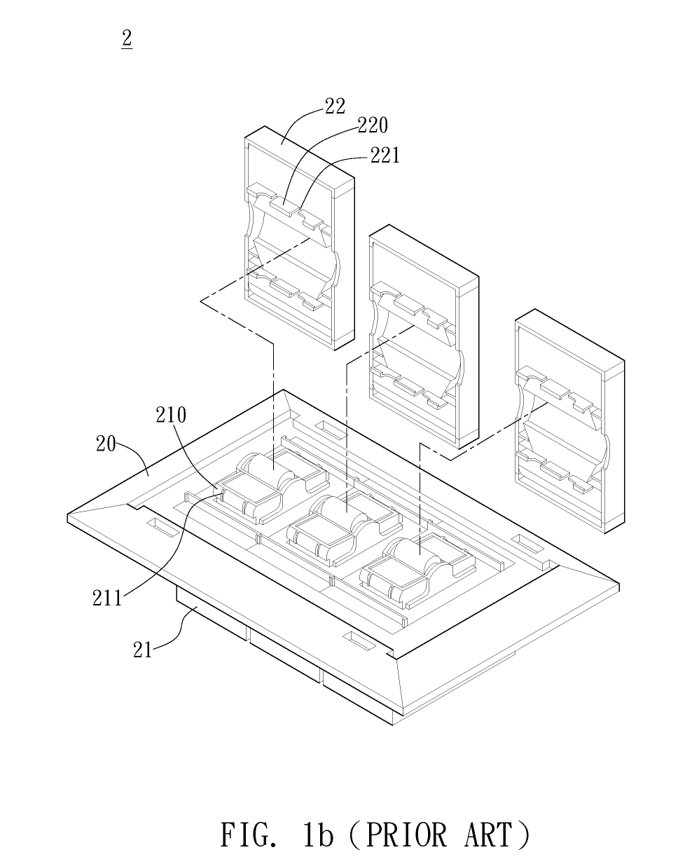

FIG. 2 illustrates a first embodiment of the circuit-switching device in accordance with the present invention. As shown, the circuit-switching device 3 of the present invention consists of a frame body 30 formed with an opening 300 and a plurality of first coupling portions 301 disposed along the periphery of the opening 300; at least an electric control unit 31 comprising a circuit switch 310 and a control member 311, the control member 311 being disposed in a swinging manner and exposed from the circuit switch 310 for controlling the circuit switch 310, wherein the control member 311 is a T-shaped structure, and the portions of the control member 311 exposed from the circuit switch 310 have a plurality of first positioning portions 3110, 3111 and a first coupling portion 3112 formed thereon, while the circuit switch 310 is provided with a second coupling portion 3100 corresponding to the first coupling portions 301 along the periphery of the opening 300 of the frame body 30; and at least an operative element 32 having an operating face 320 and a coupling face 321 opposite to the operating face 320, the coupling face 321 having a plurality of second positioning portions 323 and second coupling portions 322 formed thereon in an alternative manner, such that when the operative element 32 is coupled to the control member 311, each of the second coupling portions 322 is coupled to the first coupling portions 3112, and each of the second positioning portions 323 is engaged with the first positioning portions 3111, respectively.

In this preferred embodiment, the first positioning portions 3110, 3111, the second positioning portion 3100, and the first coupling portions 3112 are all protrusions.

In addition, one end of the circuit switch may further comprise an indicator light 3101; one end of the control member 311 may comprise a first limiting portion 3113; and the operative member 32 may further comprise a second limiting portion 324 corresponding to the first limiting portion 3113, the first limiting portion 3113 being a groove and the second limiting portion 324 being a rib protrusion corresponding to the groove. In that the other end of the control member 311 does not have a corresponding groove, the operative element 32 cannot be installed when assembled in the reverse direction. Note that the first limiting portion 3113 and the corresponding second limiting portion 324 may be optionally included in other embodiments.

The operative member 311 is formed with a slot 325 corresponding to the indicating light 3101 and penetrating through the operative face 320 and the coupling face 321 thereof, and a light-permeable cover 326 may be optionally included therein, wherein the coupling face 321 is provided with a pressing portion 327 for abutting against an edge end of the light-permeable cover 326. After the circuit-switching device 3 is assembled, the control member 311 tightly abuts against the pressing portion 327, thereby holding the light-permeable cover 326 in the slot 325 by the pressing portion 327.

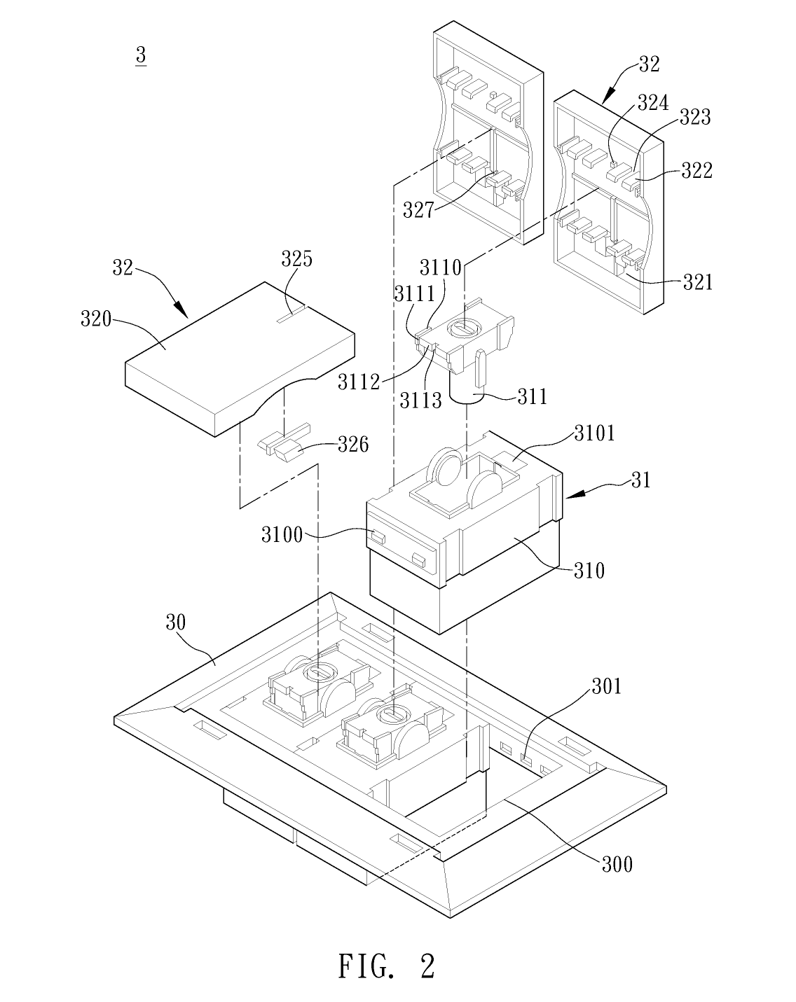

FIG. 3 is a side cross-sectional view showing the light-permeable cover 326 installed in the slot 325 by the pressing portion 327. As depicted, the light-permeable cover 326 is accommodated in the slot 325 with one end thereof being pressed by the pressing portion 327 so as to constrain the light-permeable cover 326 in the slot 325.

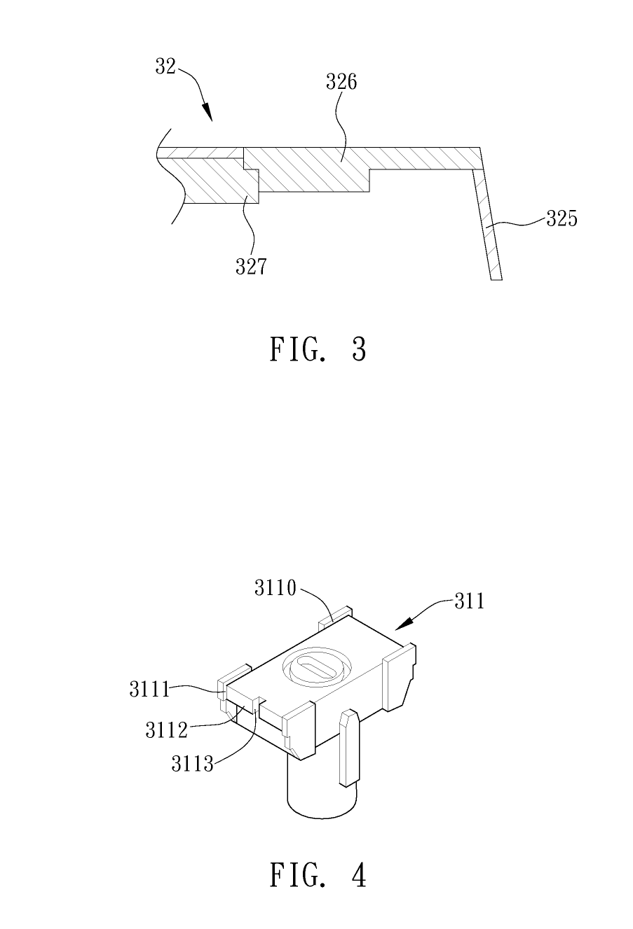

FIG. 4 is an enlarged view of the control member 311 having two top edge portions formed with a first positioning portion 3110 protruding from the top surface and another first positioning portion 3111 protruding from two ends thereof, a first coupling portion 3112, and a first positioning portion 3113 disposed at one end thereof.

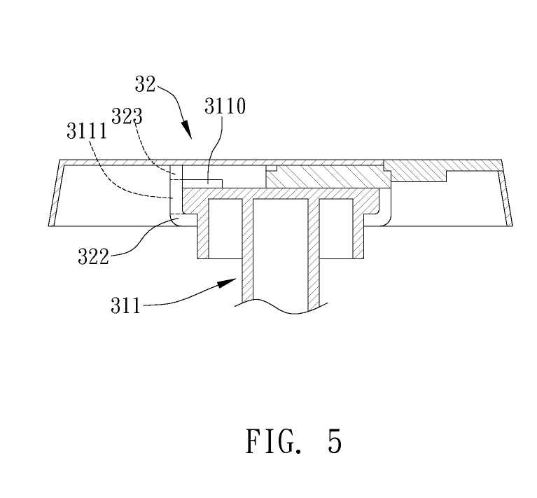

FIG. 5 is a cross-sectional side view showing the operative member 32 assembled with and coupled to the control member 311 of the circuit-switching device 3, wherein two ends of the control member 311 have a set of four first positioning portions 3111 inserted into the second positioning portion 323, while the first and second coupling portions 322 are coupled to the first coupling portion 3112 to thereby fasten the operative member 32 to the control member 311. In that the operative member 32 has multiple second positioning portions 323, it can connect with the control member 311 posited at different positions, thereby using only one structure for coupling to elements posited at different positions without the need to create more molds prior to manufacture that would otherwise increase manufacturing costs. Moreover, the first positioning portions 3110 of the control member 311 may protrude from the top end of the control member 311 so as to be connected to the second positioning portion 323 to assure accurate positioning in installation, avoiding misalignment that may cause damage to the components.

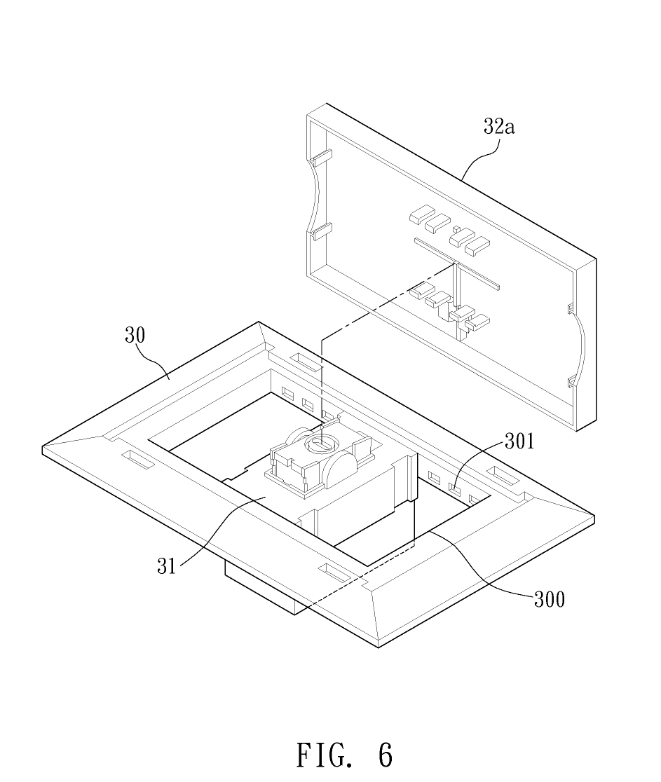

FIG. 6 is an exploded view showing a second preferred embodiment of the circuit-switching device of the present invention, which differs from the first embodiment only in that it employs a single electric control unit 31 and a single operative member 32a. The size of the operative member is made sufficient to cover the opening 300 for aesthetic purposes. The elements employed in this second embodiment are substantially the same as those used in the first embodiment, therefore like elements and structures are purposely omitted herein for brevity.

In conclusion, the circuit-switching device of the present invention is characterized by using positioning protrusions to achieve fast positioning, as well as using a plurality of different positioning portions to allow the operative member to be coupled to the control member posited at different positions, thereby avoiding the need to create and use different molds in manufacturing and also avoiding misalignments in installation that may cause damage or hazards due to misalignments and improper installation.

While illustrative embodiments are provided in the above description, such embodiments are for illustration of principles and functions of the present invention only and they are not to be construed restrictively. Various modifications and variations of the present invention will be obvious to those skilled in the art and still fall within the spirit and scope of the invention as set forth in the following claims.

What is claimed is:

1. A power circuit-switching device, comprising:
a frame body formed with an opening and a plurality of first coupling portions formed along the periphery of the opening;
at least an electric control unit having a circuit switch and a control member, wherein the control member is disposed in a swinging manner and exposed from the circuit switch, and the control member is formed with a plurality of first positioning portions and first coupling portions, and wherein the circuit switch is provided with a plurality of second coupling portions corresponding to the first coupling portions; and
at least an operative element having an operating face and a coupling face opposite to the operating face, the coupling face having a plurality of second positioning portions and second coupling portions formed thereon in an alternative manner, thereby allowing each of the second coupling portions to be coupled to the first coupling portions, and each of the second positioning portions to be coupled to first positioning portions respectively.

2. The power circuit-switching device according to claim 1, wherein one end of the circuit switch further comprises an indicator light.

3. The power circuit-switching device according to claim 1, wherein one end of the control member comprises a first limiting portion, and the operative member comprises a second limiting portion corresponding to the first limiting portion.

4. The power circuit-switching device according to claim 3, wherein the first limiting portion is a groove and the second limiting portion is a rib protrusion corresponding in position to the groove.

5. The power circuit-switching device according to claim 2, wherein the operative member is formed with a slot corresponding to the indicator light and penetrating through the operative face and the coupling face and having a light-permeable cover accommodated therein.

6. The power circuit-switching device according to claim 5, wherein the coupling face has a pressing portion for abutting against an edge end of the light-permeable cover.

7. The power circuit-switching device according to claim 1, wherein the operative member is a T-shaped structure.

8. The power circuit-switching device according to claim 1, wherein the first positioning portion, the second positioning portion, and the first coupling portion are protrusions.
